(19) United States
(12) Patent Application Publication
(10) Pub. No.: US 2010/0266334 A1
(43) Pub. Date: Oct. 21, 2010

(54) Coupling Structure

(76) Inventor: Chiang-Ko CHEN, Taipei City (TW)

Correspondence Address: G. Link Co., Ltd., 3550 Bell Road, Minooka, IL, 60447, US

(21) Appl. No.: 12/176,362

(22) Filed: Jul. 19, 2008

(30) Foreign Application Priority Data
Feb. 25, 2008 (TW) 097106521

(51) Int. Cl. F16B 7/18

(52) U.S. Cl. 403/320

(57) ABSTRACT

A coupling structure comprises a casing disposed with a bottom plate, a first side plate and a second side plate; the first side plate is disposed with at least one retaining portion; said retaining portion is disposed with a movable end and a retaining unit; the retaining unit is projected out from said first side plate toward an inner part of the casing; at least one actuating component is corresponding to the retaining portion; the actuating component is disposed with a cylindrical body and guide groove; the guide groove surrounds the cylindrical body; the cylindrical body is pivotally coupled to first side plate; the guide groove accepts the movable end.

### BACKGROUND OF THE INVENTION

1. Field of the Invention

The present invention relates to a coupling structure of a housing and components of an electronic device, and more particularly to a coupling structure free from screws between the housing and the components.

2. Description of Related Art

A general electronic product such as computer is coupled to an electronic device such as hard disc drive, burner or card reader. If an electronic product such as computer is adopted with a quick-release electronic device free from screws, the assembly and the maintenance will be allowed to be more convenient.

There are many patents concerning a quick-release structure for assembling an electronic component to a computer housing, such as Taiwan Patent No. I279180 entitled as “Housing and retaining apparatus thereof”, Taiwan Patent No. I279179 entitled as “Quick-release structure for electronic device”, Taiwan Patent No. 545681 entitled as “Rotating type fixable and quick-releasable hard disc retaining structure”, Taiwan Patent No. M275451 entitled as “Quick-releasable computer housing structure of a storage device” and Taiwan Patent Publishing No. 200524507 entitled as “Quick-releasable structure of disc module”.

### SUMMARY OF THE INVENTION

For further allowing a housing of an electronic product such as computer to be coupled to a plurality of casings, and the casings are used to be convenient for assembling and detaching an electronic device such as optical disc drive, card reader and hard disc drive, the present invention is proposed.

The main object of the present invention is to provide a coupling structure, utilizing a simple actuating component to drive a retaining portion of a casing to be convenient for assembling various electronic products.

Another object of the present invention is to provide a coupling structure, utilizing a casing disposed with openings respectively at front and rear ends to allow two electronic devices to be assembled or detached quickly so as to save the assembly time of electronic devices more.

A sectionalized coupling structure of the present invention, comprising:

a casing, disposed with a bottom plate, a first side plate and a second side plate; the first side plate being disposed with at least one retaining portion; the retaining portion being disposed with a movable end and a retaining unit; the retaining unit being projected out form the first side plate to an inside of the casing;
at least one actuating component, corresponding to the retaining portion; the actuating component being disposed with a cylindrical body and a guide groove; the guide groove being positioned around the cylindrical body; the cylindrical body being pivotally coupled to the first side plate; the guide groove accepting the movable end; whereby, when the cylindrical body is revolved, the cylindrical body drives the movable end to move toward a direction close to or apart from the inside of the casing, and further allows the retaining unit to move toward or apart from the inside of the casing to enable an electronic device such as optical disc drive, card reader or hard disc drive to be assembled in or detached from the casing conveniently.

### BRIEF DESCRIPTION OF THE DRAWINGS

The present invention can be more fully understood by reference to the following description and accompanying drawings, in which:

FIG. 1 is a perspective view, showing a coupling structure of a first preferred embodiment of the present invention;

FIG. 2 is a perspective view, showing a coupling structure turned upside down of the first embodiment according to the present invention;

FIG. 3 is a perspective view, showing a first actuating component of the present invention;

FIG. 4 is a perspective view, showing a second actuating component of the present invention;

FIG. 5 is a rear view, showing a coupling structure of the first embodiment according to the present invention;

FIG. 6 is a perspective view, showing a coupling structure of the first embodiment according to the present invention separated from a first seat and a second seat;

FIG. 7 is a perspective view, showing a coupling structure of the first embodiment according to the present invention coupled to a first seat and a second seat; and

FIG. 8 is a perspective view, showing a casing of the first embodiment and a second preferred embodiment according to the present invention coupled to a housing.

### DETAILED DESCRIPTION OF THE PREFERRED EMBODIMENTS

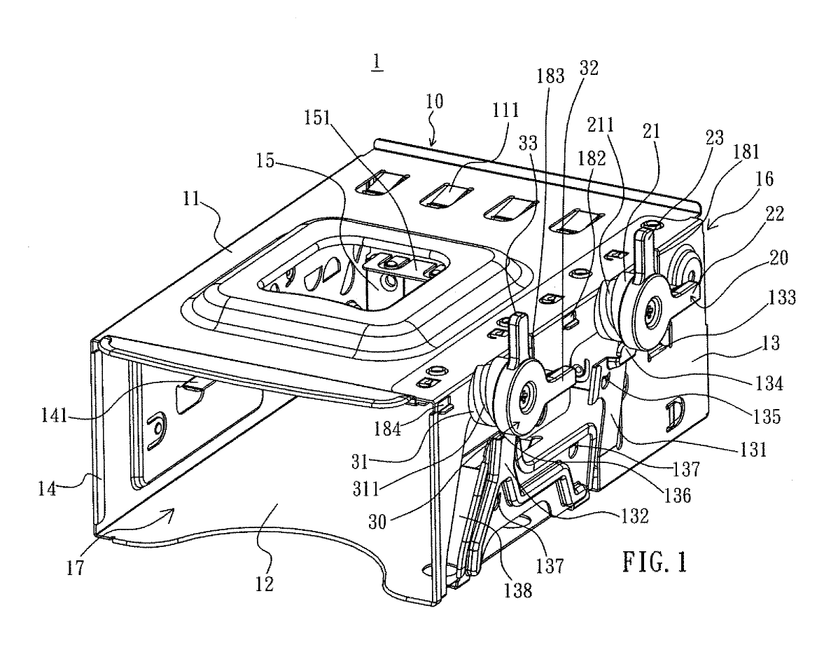

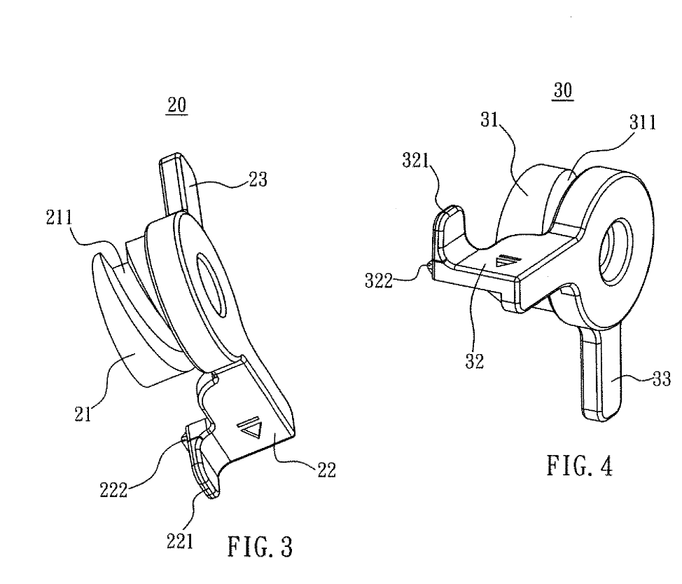

Please refer to FIGS. 1 to 5. A coupling structure 1 of a first preferred embodiment according to the present invention comprises a casing 10, a first actuating component 20 and a second actuating component 30.

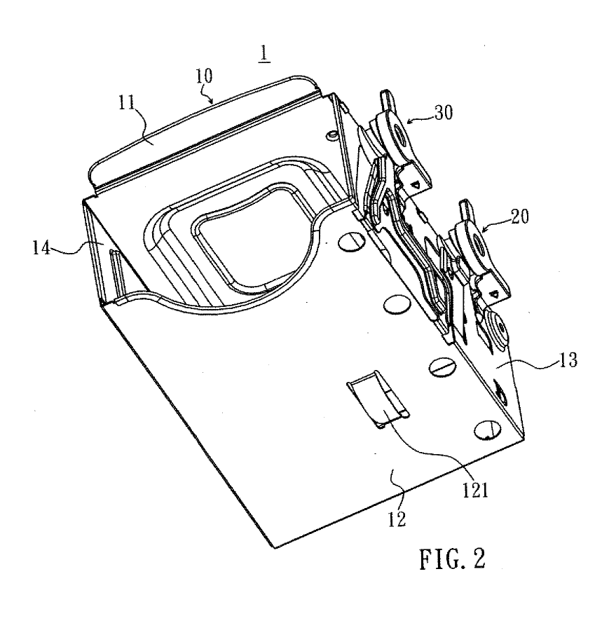

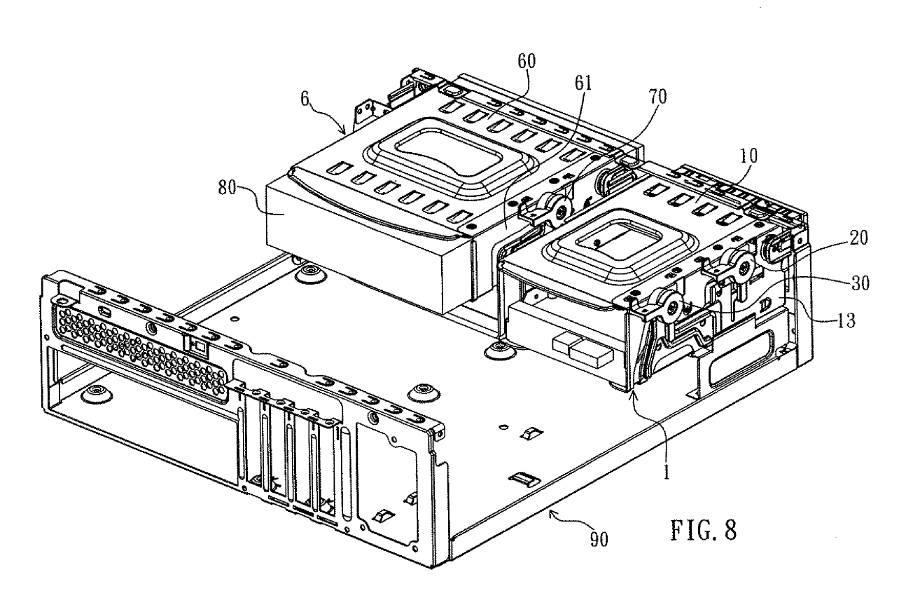

The casing 10 is disposed with a upper plate 11, a bottom plate 12, a first side plate 13, a second side plate 14 and a front plate 15. A front end of the upper plate 11 is disposed with a plurality of resilient sheets 111 inclined downward from a front side toward a rear side; the resilient sheets 111 are used to compress a first electronic device placed below the upper plate 11. The bottom plate 12 is disposed with a resilient sheets 121 projected out curvedly downward as shown in FIG. 2; the resilient sheet 121 is used for propping against an article below the bottom plate 12, for example, propping elastically against a bottom plate of a housing 90 show in FIG. 8 to enable the casing 10 to be positioned and not to be swayed about.

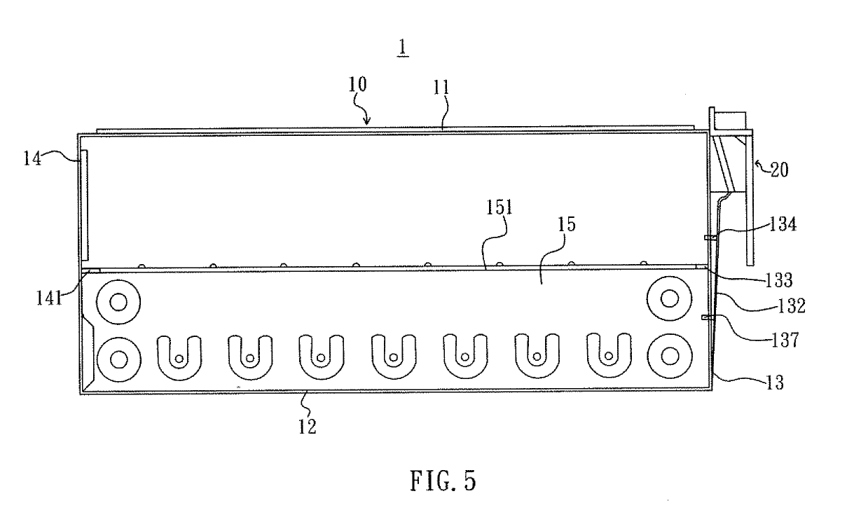

The first side plate 13 is disposed with a first retaining portion 131, a second retaining portion 132 and a supporting unit 133. The first retaining portion 131 is disposed with a first movable end 134 and a first retaining unit 135. The second retaining portion 132 is disposed with a second movable end 136 and a second retaining unit 137. The first side plate 13 is further disposed with a long hole 138; the long hole 138 is disposed around a periphery of the first movable end 134 and a periphery of the second movable 136 to enable the first movable end 134 and the second movable end 136 to be respectively moved toward an inside of the casing 10. The first supporting unit 133, the first retaining unit 135 and the second retaining unit 137 are respectively projected out from the first side plate 13 toward the inside of the casing 10 as FIG. 5 shows.

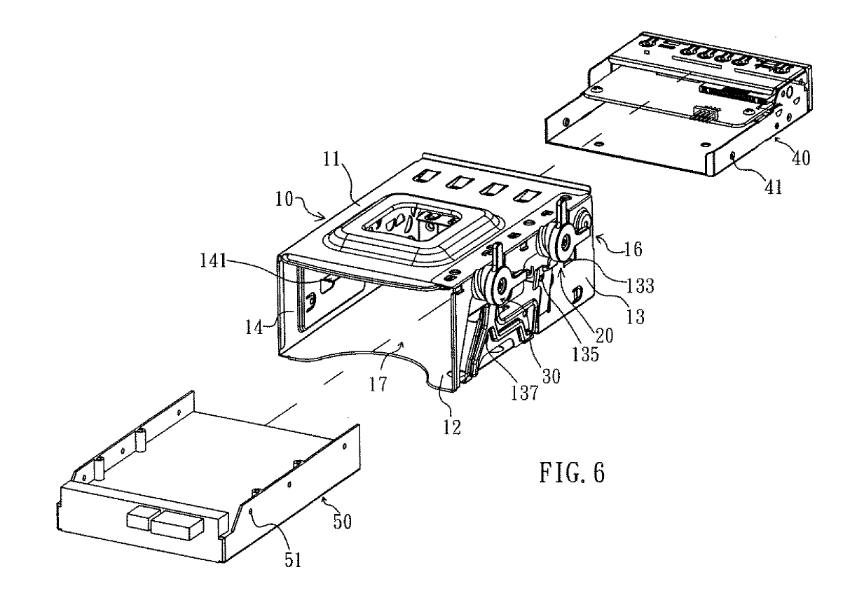

The second side plate 14 is disposed with a second supporting unit 141 projected out toward to the inside of the casing 10 as FIGS. 1, 5 and 6. The second supporting unit 141 is disposed correspondingly to the first supporting portion 133. A upper end of the front plate 15 is disposed with a third supporting unit 151 projected out toward the inside of the casing 10. The first supporting unit 133, the second supporting unit 141 and the third supporting unit 151 are all at the same level height and used for supporting a first supporting seat 40, and a space below them is used for accepting a second supporting seat 50 as FIGS. 5 and 6 show. A space exists between a upper end of the front plate 15 and the upper plate 11 to form a first opening 16 used for allowing the first supporting seat 40 to be placed in the casing 10. The upper plate 11, the bottom plate 12, the first side plate 13 and the second side plate 14 form a second opening 17 used for allowing the second supporting seat 50 to be placed in the casing 10 at a rear end of the casing 10 as shown in FIG. 6. The first supporting seat 40 is used for assembling a first electronic device such as a card reader, and the second supporting seat 50 is used for assembling a second electronic device such as a hard disc drive.

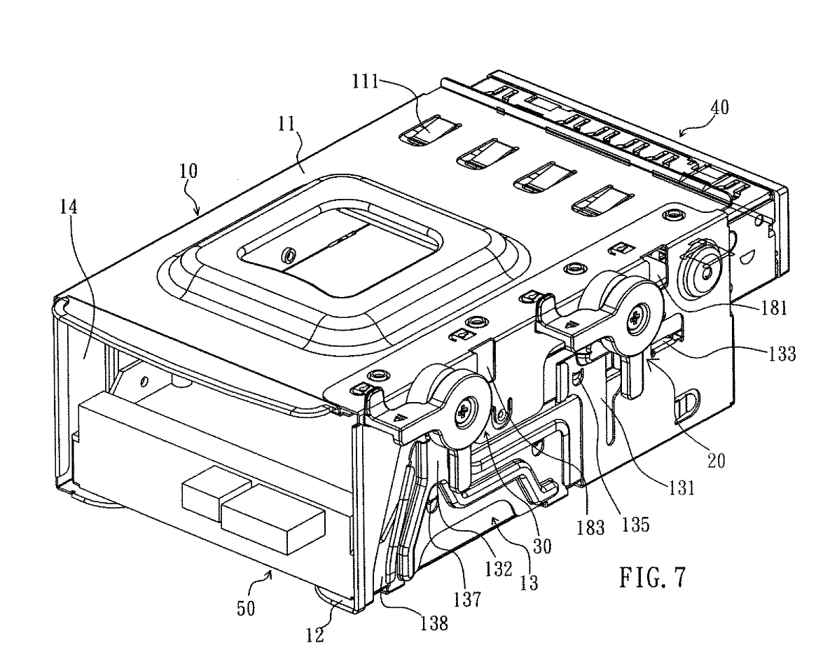

The first actuating component 20 is corresponding to the first retaining portion 131 as FIGS. 1, 3 and 6 show. The first actuating component 20 is disposed with a first cylindrical body 21, a first pushing mass 22 and a first blocking mass 23. The first cylindrical body 21 is pivotally coupled to the first side plate 13; the first pushing mass 22 and the first blocking mass 23 are respectively connected to the first cylindrical body 21 and perpendicular to each other correspondingly to a periphery of the first cylindrical body 21. The first cylindrical body 21 can respectively be driven to rotate through the first pushing mass 22 and the first blocking mass 23. The first actuating component 20 is further disposed with a first guide groove 211 formed spirally around the first cylindrical body 21; the first guide groove 211 is used for accepting the first movable end 134. When the first cylindrical body 21 is rotated, it can drive the first movable end 134 to move close toward or leave away from the inside of the casing 10 and further to insert in or separate from a corresponding first buckling hole 41 on the first supporting seat 40 (please refer to FIG. 6) to enable the first supporting seat 40 to be assembled in or detached from the inside of the casing 10. One side of the first pushing mass 22 adjacent to the first side plate 13 is disposed with a first tab 221 and a first rib 222. The first side plate 13 is disposed with a first through hole 181 and a second through hole 182 corresponding to the moving scope of the first rib 222. The first through hole 181 and the second through hole 182 are extended up to the upper plate 11. Moreover, the first rib 222 is allowed to separate from the first through hole 181 or the second through hole 182 by exerting a force on the first tab 221. The first rib 222 may be respectively limited in the first through hole 181 or the second through hole 182 to limit a rotating angle of the first actuating component 20 and allow the first retaining unit 135 to be positioned at a position of not buckling the first supporting seat 40 or a position of buckling the first supporting seat 40 as FIG. 7 shows. When the first rib 222 is engaged within the first through hole 181, the first blocking mass 23 is projected out of upper sides of the upper plate 11 and the first side plate 13 to be able to stop other articles from being attached onto the upper plate 11.

The second actuating component 30 is corresponding to the second retaining portion 132 as FIGS. 1, 4 and 6 show. The second actuating component 30 and the first actuating component 20 have the same shape, structure and function. The second actuating component 30 is disposed with a second cylindrical body 31, a second pushing mass 32 and a second blocking mass 33. The second actuating component 30 is further disposed with a second guide groove 311 spirally around the second cylindrical body 31. One side of the second pushing mass 32 adjacent to the first side plate 13 is disposed with a second tab 321 and a second rib 322.

The second cylindrical body 31 is pivotally coupled to the first side plate 13; the second cylindrical body 31 can respectively be driven to rotate through the second pushing mass 32 and the second blocking mass 33.

The second guide groove 311 is used for accepting the second movable end 136. When the second cylindrical body 31 is rotated, it can drive the second movable end 136 to move close toward or leave away from the inside of the casing 10 and further to insert in or separate from a corresponding second buckling hole 51 on the second supporting seat 50 to enable the second supporting seat 50 to be assembled in or detached from the inside of the casing 10.

The first side plate 13 is disposed with a third through hole 183 and a fourth through hole 184 corresponding to the moving scope of the second rib 322. The third through hole 183 and the fourth through hole 184 are extended up to the upper plate 11. Moreover, the second rib 322 is allowed to separate from the third through hole 183 or the fourth through hole 184 by exerting a force on the second tab 321. The second rib 322 may be respectively limited in the third through hole 183 or the fourth through hole 184 to limit a rotating angle of the second actuating component 30 and allow the second retaining unit 137 to be positioned at a position of not buckling the second supporting seat 50 or a position of buckling the second supporting seat 50. When the second rib 322 is engaged within the third through hole 183, the second blocking mass 33 is projected out of a upper side of the upper plate 11 to be able to stop other articles from being attached onto the upper plate 11.

The second retaining portion 132 of the present embodiment is disposed with two second retaining unit 137. The first supporting unit 133, the second supporting unit 141 and the third supporting unit 151 are used for supporting a lower end of the first supporting seat 40, and a space below them is used for accepting the second supporting seat 50.

The present embodiment only needs to dispose the movable first retaining portion 131 and second retaining portion 132 on the first side plate 13; a level height of the first retaining portion 131 is higher than a level height of the second retaining portion 132. Moreover, the first retaining portion 131 and the second retaining portion 132 are respectively coupled to the first actuating component 20 and the second actuating component 30, the first actuating component 20 and the second actuating component 30 can then drive the first retaining portion 131 and the second retaining portion 132 to buckle the first supporting seat 40 and the second supporting seat 50; the structure thereof is simple and screws are exempted, the first supporting seat 40 or the second supporting seat 50 can then be buckled conveniently. Besides, the first blocking mass 23 and the second blocking mass 33 are used to supporting other articles to prevent them from attaching onto the upper plate 11. Furthermore, front and rear ends of the casing 10 are respectively disposed with the first opening 16 and the second opening 17 capable of respectively allowing the first supporting seat 40 and the second supporting seat 50 to be placed in so as to enable two electronic devices to be coupled to them conveniently.

Please refer to FIG. 8. A screw-free coupling structure 6 of a second preferred embodiment according to the present invention comprises a casing 60 and a third actuating component 70. The first side plate 61 is pivotally coupled to the only one third actuating component 70. Structures of the first side plate 61 and the third actuating component 70 are almost the same as the structures of the first side plate and the actuating component of the first embodiment and used for retaining a third supporting seat 80 inside the casing 60. The third supporting seat 80 is used for assembling the second electronic device such as a optical disc drive.

The casing 10 and 60 of the present invention may be respectively assembled in an electronic product, for example, in a computer housing 90 to allow various electronic devices to be assembled in and detached from the housing 90 conveniently.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A coupling structure, comprising:
a casing, disposed with a bottom plate, a first side plate and a second side plate; said first side plate being disposed with at least one retaining portion disposed with a movable end and a retaining unit; said retaining unit being projected out from said first side plate toward an inside of said casing; and
at least one actuating component, corresponding to said retaining portion; said actuating component being disposed with a cylindrical body and a guide groove;
said guide groove surrounding said cylindrical body;
said cylindrical body being pivotally coupled to said first side plate; said guide groove accepting said movable end;
whereby, when the cylindrical body is revolved, said cylindrical body drives said movable end to move close toward or separate from an inside of said casing, and further to allow said retaining unit to be close toward or separated from said inside of said casing.

2. The coupling structure according to claim 1, wherein said first side plate is further disposed with a long hole; said long hole is disposed around a periphery of said movable end thereby allowing said movable end to be moved close toward or separated from said inside of said casing.

3. The coupling structure according to claim 2, wherein said guide groove is spirally formed.

4. The coupling structure according to claim 3, wherein said actuating component is further disposed with a pushing mass; said pushing mass is connected to said cylindrical body thereby driving said cylindrical body to rotate through said pushing mass.

5. The coupling structure according to claim 4, wherein one side of said first side plate adjacent to said pushing mass is disposed with a rib; said first side plate is disposed with a first through hole and a second through hole corresponding to a moving scope of said rib thereby allowing said rib to be limited in said first through hole or said second through hole so as to limit a rotating angle of said actuating component.

6. The coupling structure according to claim 5, wherein said actuating component is further disposed with a blocking mass; said blocking mass is connected to said cylindrical body; wherein said blocking mass is projected out above said first side plate when said rib is engaged within said first through hole.

7. The coupling structure according to claim 6, wherein said pushing mass and said blocking mass are disposed perpendicularly to each other correspondingly to an periphery of said cylindrical body.

8. The coupling structure according to claim 7, wherein one side of said pushing mass adjacent to said first side plate is further disposed with a tab.

9. The coupling structure according to claim 8, wherein said casing is further disposed with a front plate and a upper plate.

10. The coupling structure according to claim 9, wherein a front end of said upper plate is disposed with a plurality of resilient sheets inclined downward from a front side toward a rear side of each thereof.

11. The coupling structure according to claim 10, wherein said bottom plate is disposed with a resilient sheet projected out downward curvedly.

12. The coupling structure according to claims 1, wherein said at least one retaining portion comprises a first retaining portion and a second retaining portion; said first retaining portion is disposed with a first movable end and a first retaining unit; said second retaining portion is disposed with a second movable end and a second retaining unit; said at least one actuating component comprises a first actuating component and a second actuating component; said first retaining portion is coupled to said first actuating component, said second retaining portion is coupled to said second actuating component, wherein a level height of said first retaining unit is higher than a level height of said second retaining unit; said first side plate is further disposed with a first supporting unit; said first supporting unit is projected out from said first side plate toward said inner side of said casing; said second side plate is further disposed with a second supporting unit; said second supporting unit is projected out from said second side plate toward said inner side of said casing; said first supporting unit and said second supporting unit are disposed correspondingly to each other and has the same level height thereby being used for supporting a first supporting seat; a space below said first supporting unit and said second supporting unit is used for accepting a second supporting seat.

13. The coupling structure according to claim 12, wherein said casing is further disposed with a front plate; a upper end of said front plate is disposed with a third supporting unit projected out toward said inside of said casing; said third supporting unit and said first supporting unit, said second supporting unit have the same level height.

14. The coupling structure according to claim 13, wherein said casing is further disposed with a upper plate; a space exists between an upper end of said front plate and said upper plate to form a first opening used for allowing said first supporting seat to be placed in said casing; said upper plate, said bottom plate, said first side plate and said second side plate forms a second opening used for allowing said second supporting seat to be placed in said casing at a rear end of said casing.

15. The coupling structure according to claim 14, wherein a front end of said upper plate is disposed with a plurality of resilient sheets inclined downward from a front side toward a rear side of each thereof.

16. The coupling structure according to claim 15, wherein said bottom plate is disposed with a resilient sheet projected out downward curvedly.
